(19) United States
(12) Patent Application Publication
(10) Pub. No.: US 2010/0145652 A1
(43) Pub. Date: Jun. 10, 2010

(54) METHOD FOR ESTIMATING THE TEMPERATURE IN AN INTERNAL COMBUSTION ENGINE

(75) Inventors: Paolo CASASSO, Cuneo (IT); Fabio AUTIERI, Torino (IT); Antonio GIUFFRIDA, Mascalucia (CT) (IT); Davide CARBONE, Asti (IT); Filippo PARISI, Torino (IT)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/552,709

(22) Filed: Nov. 23, 2009

(30) Foreign Application Priority Data
Sep. 2, 2008 (GB) 0815907.1

(51) Int. Cl. G01K 7/16; G06F 15/00

(52) U.S. Cl. 702/130; 374/183; 374/E07.018

(57) ABSTRACT

A method and circuit are provided for estimating the temperature in an internal combustion engine. The method includes, but is not limited to the steps of providing a sensor resistor (RTD) in the internal combustion engine, the sensor resistor (RTD) having a predetermined resistance-temperature characteristic, and estimating the temperature based on the resistance-temperature characteristic. The method also includes, but is not limited to the steps of providing to the sensor resistor (RTD) a reference current signal (I1) so that a sensor voltage (V_{RTD}) is established across the sensor resistor (RTD), generating a reference voltage signal (V2), comparing the established sensor voltage (V_{RTD}) with the reference voltage signal (V2), modifying the reference current signal (I1) and reference voltage signal (V2) on the basis of the comparison outcome so as to minimize the difference between the sensor voltage (V_{RTD}) and the reference voltage signal (V2), and calculating the resistance value of the sensor resistor (RTD) based on the reference voltage signal (V2) and reference current signal (I1).

### CROSS-REFERENCE TO RELATED APPLICATION

This application claims priority to British Patent Application No. 0815907.1, filed Sep. 2, 2008, which is incorporated herein by reference in its entirety.

### TECHNICAL FIELD

The present invention relates to the estimation of the temperature in an internal combustion engine and specifically to a method for estimating the temperature in an internal combustion engine, and a corresponding circuit.

### BACKGROUND

Linear resistive temperature sensors (“RTD”) are today utilized in automotive control to monitor the high temperature in the exhaust pipes and in the catalyst of internal combustion engines, both diesel and gasoline engines.

The temperature to be monitored covers a wide range, from −40° C. to 1000° C., and the corresponding sensor resistance variation is typically from 170Ω to 850Ω, with quasi-linear temperature dependency. The resolution of the temperature measurement is therefore limited and measurement errors have a greater impact on the automotive control.

A conventional conditioning circuit for RTD sensors used in automotive controllers is shown in FIG. 1. This circuit comprises a very accurate pull-up resistor R₁, particularly having a value of 1 kΩ, connected to an accurate supply voltage source Vcc, for example having a value of 5V. A sensor resistor RTD, which is a linear resistive temperature sensor, is connected in series between the pull-up resistor R₁ and a voltage reference, particularly a ground conductor GND. A low pass filter 2 comprising a resistor R_{f} and a capacitor C_{f} is connected in parallel to the sensor resistor RTD, and is used to reduce the noise from the electrical environment. An analogue to digital converter ADC is connected in parallel to the filter 2 and is also connected to a reference voltage source V_{ADC} that tracks the supply voltage source Vcc. A microprocessor M is connected between the converter ADC and an output OUT of the circuit. Alternatively, the converter ADC is embedded in the microprocessor M.

A voltage Vₘₑₐₛ across the sensor resistor RTD is measured at a node A with respect to ground, and applying an equation as follows:

$${V}_{meas} = \frac{RTD}{{R}_{1} + RTD} {V}_{cc}$$

The resistance value of the sensor resistor RTD is obtained. Specifically, the voltage Vₘₑₐₛ across the sensor resistor RTD is measured in a known manner and it is supplied to the converter ADC that provides a digital value corresponding to the voltage. The digital value is supplied to the microprocessor M which calculates, according to the above cited equation, the resistance value of the sensor resistor RTD. Knowing the dependency between the resistance value of the sensor resistor RTD and the temperature, it is possible to obtain, at the output OUT of the circuit, the estimated value of the temperature.

The overall accuracy of the temperature measurement is mainly affected by: sensor resistance accuracy; conditioning circuit tolerances; quantization steps of the converter ADC; conversion errors of the converter ADC; and leakage current of the converter ADC through the low pass filter 2.

The drawbacks of such architecture is that: it utilizes less than half span of the available converter input voltage range; the transfer function is non linear due to the voltage divider arrangement between the pull-up resistor R₁ and the sensor resistor RTD; the sensitivity ΔVₘₑₐₛ/ΔTemperature is very low, for example not higher than 1.2 mV/° C. at about 600° C.; the sensitivity ΔVₘₑₐₛ/ΔTemperature is not constant and decreases with the increase of the temperature; a very accurate and expensive pull-up resistor, particularly with 0.1% of tolerance, is required; and an analogue to digital converter, which is an expensive element, is needed.

In view of the above, it is at least one object of the present invention to provide an alternative method for estimating the temperature in an internal combustion engine so as to improve the overall accuracy and sensitivity without the need to use complex circuits with expensive electronic components. In addition, it other objects, desirable features, and characteristics will become apparent from the subsequent summary and detailed description, and the appended claims, taken in conjunction with the accompanying drawings and this background.

### SUMMARY

1. A method is provided in accordance with an embodiment of the invention for estimating the temperature in an internal combustion engine. The method includes, but is not limited to the steps of providing a sensor resistor (RTD) in the internal combustion engine, the sensor resistor (RTD) having a predetermined resistance-temperature characteristic. The method also includes, but is not limited to estimating the temperature based on the resistance-temperature characteristic, providing to the sensor resistor (RTD) a reference current signal (I1) so that a sensor voltage (V_{RTD}) is established across the sensor resistor (RTD), generating a reference voltage signal (V2), comparing the established sensor voltage (V_{RTD}) with the reference voltage signal (V2), modifying the reference current signal (I1) and reference voltage signal (V2) on the basis of the comparison outcome so as to minimize the difference between the sensor voltage (V_{RTD}) and the reference voltage signal (V2), and calculating the resistance value of said sensor resistor (RTD) based on said reference voltage signal (V2) and reference current signal (I1).

In addition to the method, a circuit is provided for estimating the temperature in an internal combustion engine. The circuit includes, but is not limited to a sensor resistor (RTD) having a predetermined resistance-temperature characteristic, a computer connected in parallel to the sensor resistor (RTD) and arranged to estimate a temperature value using the resistance-temperature characteristic of the sensor resistor (RTD), and electronic controller coupled to the sensor resistor (RTD) and arranged for providing to the sensor resistor (RTD) a reference current signal (I1) so that a sensor voltage (VRTD) is established across the sensor resistor (RTD), generating a reference voltage signal (V2), comparing the established sensor voltage (VRTD) with the reference voltage signal (V2), modifying the reference current signal (I1) and reference voltage signal (V2) on the basis of the comparison outcome so as to minimize the difference between the sensor voltage (VRTD) and the reference voltage signal (V2), and calculating the resistance value of the sensor resistor (RTD) based on the said reference voltage signal (V2) and reference current signal (I1).

### BRIEF DESCRIPTION OF THE DRAWINGS

The present invention will hereinafter be described in conjunction with the following drawing figures, wherein like numerals denote like elements, and:

FIG. 1 is a schematic representation of a conditioning circuit for a temperature sensor of the prior art; and

FIG. 2 is a schematic representation of a conditioning circuit for a temperature sensor according to an embodiment of the invention.

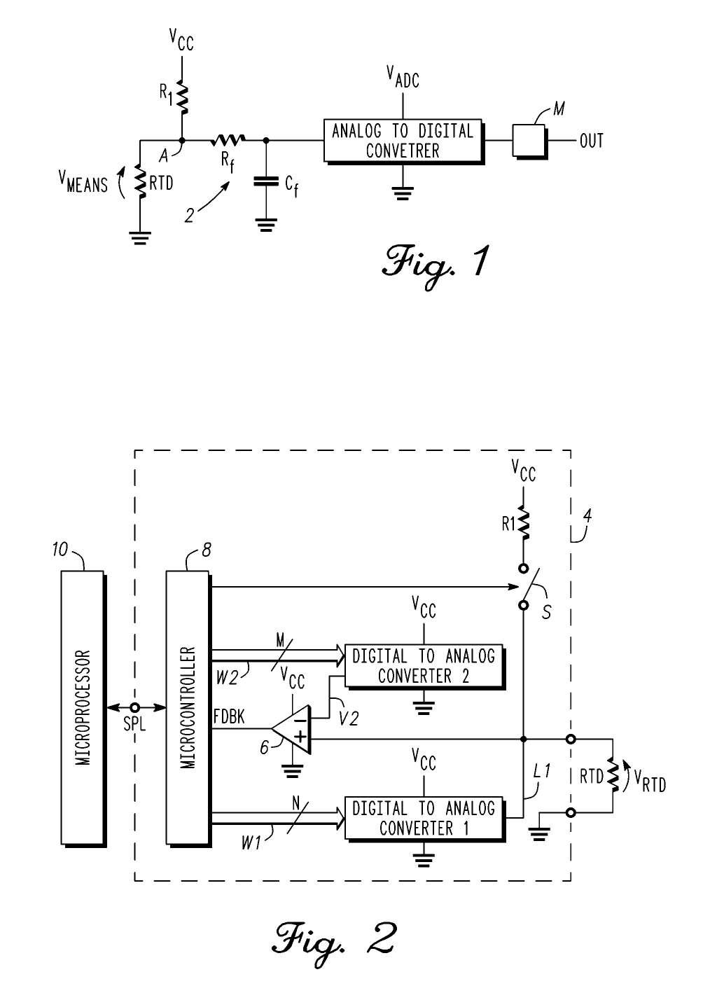

### DETAILED DESCRIPTION

The following detailed description is merely exemplary in nature and is not intended to limit application and uses. Furthermore, there is no intention to be bound by any theory presented in the preceding background or the following detailed description.

In FIG. 2, reference numeral 4 generally indicates an electronic control system for driving a sensor resistor RTD, which is a linear resistive temperature sensor (i.e. a resistor having a linear resistance-temperature characteristic). The sensor resistor RTD can be either of the NTC type or the PTC type.

The sensor resistor RTD is connected to the output of a digitally-driven analogue current generator DAC1, typically a digital-analogue converter, which has its input connected to a microcontroller 8. The generator DAC1 provides at its output a reference current signal I1 having an analogue value which corresponds to the digital value of a first N-bit digital control word W1 provided at its input by the microcontroller 8. The reference current I1 flows through the sensor resistor RTD and a sensor voltage V_{RTD} is established across said sensor resistor RTD.

The sensor resistor RTD is also connected to the non-inverting input of an analogue comparator 6, which continuously compares the said sensor voltage V_{RTD} with an analogue reference voltage signal V2 provided by the output of a digitally-driven analogue voltage generator DAC2, typically a digital-analogue converter, which has its input connected to the microcontroller 8. The generator DAC2 provides at its output the reference voltage signal V2 having an analogue value which corresponds to the digital value of a second M-bit digital control word W2 provided at its input by the microcontroller 8.

The generators DAC1 and DAC2 are each connected to a DC supply voltage source, such as the battery of the motor-vehicle, which provides a supply voltage V_{cc}.

The microcontroller 8 receives an output signal FDBK from the comparator 6 and performs a closed-loop control so as to minimize the difference between the analogue values of the sensor voltage signal V_{RTD} and the reference voltage signal V2. The microcontroller 8 sets values of the first N-bit digital control word W1 and second digital word W2 so as to get the minimization.

In order to achieve the best resistance resolution ΔR, i.e. the resolution of the resistance value of the RTD sensor, two different operating modes can be implemented by the microcontroller 8, according to the resolution of the two generators DAC1 and DAC2: the resolution of the current generator DAC1 is indicated ΔI, the resolution of the voltage generator DAC2 is indicated ΔV.

In order to distinguish between the two different cases above cited, it is firstly considered that the voltage generator DAC2 is fixed and the current generator DAC1 switches. In this case, the resistance value of the sensor resistor RTD is calculated according to an equation as follows:

$$RTD = \frac{{V}_{DAC 1}}{{I}_{DAC 1}} \qquad ( 1 )$$

Where V_{DAC2} is the analogue reference voltage signal V2 and I_{DAC1} is the analogue reference current signal I1.

The resistance resolution ΔR is calculated according to the following equations:

$$RTD + Δ R = \frac{{V}_{DAC 2}}{{I}_{DAC 1} - Δ I} \qquad ( 2 )$$

and by combining equations 1 and 2:

$$Δ R = \frac{{V}_{DAC 2} Δ I}{{I}_{DAC 1} ( {I}_{DAC 1} - Δ I )} \qquad ( 3 )$$

Secondly, it is considered that the current generator DAC1 is fixed and the voltage generator DAC2 switches. In this case, the resistance resolution ΔR is calculated according to the following equation:

$$Δ R = \frac{Δ V}{{I}_{DAC 1}} \qquad ( 4 )$$

Comparing the two equations of the resistance resolution ΔR:

$$\frac{{V}_{DAC 2} \cdot Δ I}{{I}_{DAC 1} \cdot ( {I}_{DAC 1} - Δ I )} < \frac{Δ V}{{I}_{DAC 1}} ⇒ \frac{{V}_{DAC 2}}{( {I}_{DAC 1} - Δ I )} < \frac{Δ V}{Δ I} \qquad ( 5 )$$

By combining equation 2 and 5 it is obtained:

$$RTD + Δ R < \frac{Δ V}{Δ I} ⇒ RTD < \frac{{V}_{DAC 2}}{( {I}_{DAC 1} - Δ I )} < 2 RTD \qquad ( 6 )$$

At this point, two hypothesis can be made; firstly, it is supposed that:

$${RTD}_{expected} > \frac{Δ V}{Δ I} \qquad ( 7 )$$

Where RTD_{expected} is an expected resistance value of the resistor RTD, and therefore, according to equation 6:

$$\frac{{V}_{DAC 2}}{( {I}_{DAC 1} - Δ I )} > \frac{Δ V}{Δ I} \qquad ( 8 )$$

Secondly, it is supposed that:

$$2 {RTD}_{expected} < \frac{Δ V}{Δ I} \qquad ( 9 )$$

and therefore, according to equation 6:

$$\frac{{V}_{DAC 2}}{( {I}_{DAC 1} - Δ I )} < \frac{Δ V}{Δ I} \qquad ( 10 )$$

From equations 7 and 9 it is obtained:

$$\begin{matrix}{RTD}_{expected} > \frac{Δ V}{Δ I} & ( 11 ) \\ {RTD}_{expected} < \frac{Δ V}{2 Δ I} & ( 12 )\end{matrix}$$

From equations 11 and 12 two conditions can be obtained, based on the expected resistance value of the resistor RTD_{expected} and the resolutions of the current generator DAC1 and voltage generator DAC2.

In the first case, the expected resistance value of the sensor resistor RTD to be measured is greater than ΔV/ΔI.

The current generator DAC1 starts to inject its maximum current, for example 10 mA. The voltage generator DAC2 is set to its maximum voltage, for example 4V.

If the output signal FDBK is “low”, i.e. the reference voltage signal V2 is greater than the sensor voltage V_{RTD}, the microcontroller 8 makes the voltage generator DAC2 reduce its reference voltage signal V2 of a predetermined quantity, for example 0.2V. This step is repeated until the output signal FDBK changes status, i.e., becomes “high”. At this point, the resistance value of the sensor resistor RTD is calculated according to equation 1.

If the output signal FDBK is “high”, i.e., the reference voltage signal V2 is lower than the sensor voltage V_{RTD}, the microcontroller 8 makes the current generator DAC1 reduce its reference current signal I1 of a predetermined quantity, for example 1 mA. This step is repeated until the output signal FDBK changes status, i.e., becomes “low”, or until the current generator DAC1 arrives to its minimum value, for example 5 mA.

If the output signal FDBK becomes “low”, the microcontroller 8 makes the voltage generator DAC2 reduce its reference voltage signal V2 of a predetermined quantity, for example 0.2V. This step is repeated until the output signal FDBK changes status again, i.e., becomes “high”. After that, the resistance value of the sensor resistor RTD is calculated according to equation 1.

If the current generator DAC1 is equal to its minimum value and the output signal FDBK is still “high”, the microcontroller 8 turns on a switch S and connects a pull-up resistor R1 essentially in series with the sensor resistor RTD, between the voltage supply Vcc and ground. If the output signal FDBK does not change status, an “open circuit fault condition” is detected.

In the second case, the expected resistance value of the sensor resistor RTD to be measured is smaller than ΔV/2ΔI.

The current generator DAC1 starts to inject its maximum current, for example 10 mA. The voltage generator DAC2 is set to its maximum voltage, for example 4V.

If the output signal FDBK is “high”, the microcontroller 8 makes the current generator DAC1 reduce its reference current signal I1 of a predetermined quantity, for example 1 mA. This step is repeated until the output signal FDBK changes status, i.e., becomes “low”. At this point, the resistance value of the sensor resistor RTD is calculated according to equation 1.

If the output signal FDBK is “low”, the microcontroller 8 makes the voltage generator DAC2 reduce its reference voltage signal V2 of a predetermined quantity, for example 0.2V. This step is repeated until the output signal FDBK changes status, i.e., becomes “high”, or until the voltage generator DAC2 arrives to its minimum value. At this point, the microcontroller 8 makes the current generator DAC1 reduce its reference current signal I1 of a predetermined quantity, for example 1 mA. This step is repeated until the output signal FDBK changes status again, i.e., becomes “low”. At this point, the resistance value of the sensor resistor RTD is calculated according to equation 1.

In the above identified case, if the voltage generator DAC2 is equal to its minimum value and the output signal FDBK is still “low”, a “short circuit fault condition” is detected.

If neither equation 11 nor equation 12 are satisfied, it is not possible to know whether the first case is better than the second one or vice versa. The microcontroller 8 performs therefore the steps of the first case or of the second one indifferently, or according to a default rule.

The microcontroller 8 is arranged to transmit data to a microprocessor 10 through a serial peripheral interface SPI. Particularly, the microcontroller 8 transmits the calculated resistance value of the RTD sensor. Alternatively, the microcontroller 8 transmits both the reference voltage V2 and the reference current I1 and the microprocessor 10 calculates the resistance value of the RTD sensor.

Advantageously, a multiplexer is connected between the sensor resistor RTD and the output of the current generator DAC1 so as to allow measuring the resistance values of a plurality of sensor resistors.

Alternatively, if an expected resistance value of the sensor resistor RTD is not known, the comparison between the two equations of the resistance resolution ΔR can be made by comparing the first digital word W1 and second digital word W2. Particularly, in equation 5 is it possible to substitute W1*ΔI for I_{DAC1} and W2*ΔV for V_{DAC2}, thus obtaining:

$$\frac{W 2 Δ V}{Δ I ( W 1 - 1 )} < \frac{Δ V}{Δ I} ⇒ W 2 < W 1 - 1 \qquad ( 13 )$$

If equation 13 is satisfied, the second case above disclosed is followed; otherwise, the steps of the first case are selected.

Clearly, the principle of the invention remaining the same, the embodiments and the details of production can be varied considerably from what has been described and illustrated purely by way of non-limiting example, without departing from the scope of protection of the present invention as defined by the attached claims. Moreover, while at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for estimating a temperature in an internal combustion engine, the method comprising the steps of:
providing a sensor resistor (RTD) in said internal combustion engine, said sensor resistor (RTD) having a predetermined resistance-temperature characteristic;
estimating the temperature based on the predetermined resistance-temperature characteristic;
providing to the sensor resistor (RTD) a reference current signal (I1) so that a sensor voltage (V_{RTD}) is established across the sensor resistor (RTD);
generating a reference voltage signal (V2);
comparing the sensor voltage (V_{RTD}) with the reference voltage signal (V2);
modifying the reference current signal (I1) and the reference voltage signal (V2) on a basis of the comparison outcome so as to minimize a difference between the sensor voltage (V_{RTD}) and the reference voltage signal (V2); and
calculating a resistance value of said sensor resistor (RTD) based on said reference voltage signal (V2) and the reference current signal (I1).

2. The method according to claim 1, further comprising the steps of:
determining a first resolution (ΔI) associated with said reference current signal (I1);
determining a second resolution (ΔV) associated with said reference voltage signal (V2);
comparing said first resolution (ΔI) and the second resolution (ΔV) with an expected value of said sensor resistor (RTD); and
modifying the reference current signal (I1) and the reference voltage signal (V2) according to results of said comparison.

3. The method according to claim 1, wherein the resistance value of said sensor resistor (RTD) is calculated according to an equation as follows:
$$RTD = \frac{{V}_{DAC 2}}{{I}_{DAC 1}}$$
where V_{DAC2} is the reference voltage signal (V2) and I_{DAC1} is the reference current signal (I1).

4. The method according to claim 1, wherein the reference current signal (I1) and the reference voltage signal (V2) are fixed at predetermined values and at least one of the reference current signal (I1) or the reference voltage signal (V2) are decreased, according to said comparison outcome, so as to minimize the difference between the sensor voltage (V_{RTD}) and the reference voltage signal (V2).

5. The method according to claim 1, wherein the reference current signal (I1) has an analogue value corresponding to a value of a first N-bit digital control word (W1).

6. The method according to claim 5, wherein the reference voltage signal (V2) has the analogue value corresponding to the value of a second N-bit digital control word (W2).

7. The method according to claim 6, further comprising the steps of:
comparing the value of the first N-bit digital control word (W1) and the value of the second N-bit digital control word (W2);
modifying digital values of said first N-bit digital control word (W1) and said second N-bit digital control word (W2) according to results of said comparison.

8. A circuit for estimating a temperature in an internal combustion engine, the circuit comprising:
a sensor resistor (RTD) having a predetermined resistance-temperature characteristic;
a computer connected in parallel to the sensor resistor (RTD) and arranged to estimate a temperature value using the predetermined resistance-temperature characteristic of the sensor resistor (RTD);
an electronic controller coupled to said sensor resistor (RTD) and arranged for:
providing to the sensor resistor (RTD) a reference current signal (I1) so that a sensor voltage (V_{RTD}) is established across the sensor resistor (RTD);
generating a reference voltage signal (V2);
comparing the sensor voltage (V_{RTD}) with the reference voltage signal (V2);
modifying the reference current signal (I1) and the reference voltage signal (V2) on a basis of the comparison outcome so as to minimize a difference between the sensor voltage (V_{RTD}) and the reference voltage signal (V2); and
calculating a resistance value of said sensor resistor (RTD) based on said reference voltage signal (V2) and the reference current signal (I1).

9. The circuit of claim 8, wherein the electronic controller is predisposed for:
determining a first resolution (ΔI) associated with said reference current signal (I1);
determining a second resolution (ΔV) associated with said reference voltage signal (V2);
comparing said first resolution (ΔI) and the second resolution (ΔV) with an expected value of said sensor resistor (RTD); and
modifying the reference current signal (I1) and the reference voltage signal (V2) according to results of said comparison.

10. The circuit of claim 8, wherein the electronic controller comprises a first digitally-driven analogue voltage generator (DAC1), a second digitally-driven analogue voltage generator (DAC2) and a microcontroller,
wherein the first digitally-driven analogue voltage generator (DAC1) and the second digitally-driven analogue voltage generator (DAC2) are arranged to provide the reference current signal (I1) and the reference voltage signal (V2); and
wherein the microcontroller is arranged to provide a first digital control word (W1) and a second digital control word (W2) to the first digitally-driven analogue voltage generator (DAC1) and the second digitally-driven analogue voltage generator (DAC2), said first digital control word (W1) corresponding to an analogue value of the reference current signal (I1) and said second digital control word (W2) corresponding to the analogue value of the reference voltage signal (V2).
